(19) United States
(12) Patent Application Publication
(10) Pub. No.: US 2008/0117515 A1
(43) Pub. Date: May 22, 2008

(54) Two-layered optical plate and method for making the same

(75) Inventors: Tung-Ming Hsu, Tu-Cheng (TW); Shao-Han Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/713,121

(22) Filed: Mar. 2, 2007

(30) Foreign Application Priority Data
Nov. 20, 2006 (CN) 200610201118.6

(51) Int. Cl. G02B 5/02; B29D 11/00

(52) U.S. Cl. 359/599; 264/1.6

(57) ABSTRACT

An exemplary optical plate (20) includes a transparent layer (21) and a light diffusion layer (23). The transparent layer includes a light input interface (211), a light output surface (213) opposite to the light input interface, and a plurality of micro protrusions (215) defined in the light output surface. Each of the micro protrusions includes at least three side surfaces connecting with each other. A transverse width of each side surface decreases along a direction from a base end of the micro protrusion to a distal end of the micro protrusion. The light diffusion layer is integrally formed in immediate contact with the light input interface of the transparent layer. The light diffusion layer includes a transparent matrix resins (231) and a plurality of diffusion particles (233) dispersed into the transparent matrix resins. A method for making the optical plate is also provided.

### CROSS-REFERENCE TO RELATED APPLICATIONS

This application is related to two copending U.S. patent applications, application Ser. No. 11/655425 filed on Jan. 19, 2007, entitled “TWO-LAYERED OPTICAL PLATE AND METHOD FOR MAKING THE SAME”, and application serial no. [to be advised] (US Docket No. US11887), filed on [date to be advised], entitled “TWO-LAYERED OPTICAL PLATE AND METHOD FOR MAKING THE SAME”, the inventors with respect to both co-pending applications being Tung-Ming Hsu and Shao-Han Chang. Both copending applications have the same assignee as the present application. The disclosures of the above identified copending applications are incorporated herein by reference.

### BACKGROUND OF THE INVENTION

1. Field of the Invention

The present invention generally relates to optical plates and methods for making the same, and more particularly, to an optical plate for use in, for example, a backlight module of a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light; instead, the liquid crystal needs to receive light from a light source in order to display images and data. In the case of a typical LCD panel, a backlight module powered by electricity supplies the needed light.

FIG. 13 is an exploded, side cross-sectional view of a typical backlight module 10 employing a typical optical diffusion plate. The backlight module 10 includes a housing 11, a plurality of lamps 12 disposed on a base of the housing 11, and a light diffusion plate 13 and a prism sheet 15 stacked on the housing 11 in that order. The lamps 12 emit light rays, and inside walls of the housing 11 are configured for reflecting some of the light rays upwards. The light diffusion plate 13 includes a plurality of embedded dispersion particles. The dispersion particles are configured for scattering received light rays, and thereby enhancing the uniformity of light rays that exit the light diffusion plate 13. The prism sheet 15 includes a plurality of V-shaped structures on a top thereof. The V-shaped structures are configured for collimating received light rays to a certain extent.

In use, the light rays from the lamps 12 enter the prism sheet 15 after being scattered in the diffusion plate 13. The light rays are refracted by the V-shaped structures of the prism sheet 15 and are thereby concentrated so as to increase brightness of light illumination. Finally, the light rays propagate into an LCD panel (not shown) disposed above the prism sheet 15. The brightness may be improved by the V-shaped structures of the prism sheet 15, but the viewing angle may be narrow.

In addition, the diffusion plate 13 and the prism sheet 15 are in contact with each other, but with a plurality of air pockets still existing at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical means is desired in order to overcome the above-described shortcomings. A method for making such optical means is also desired.

### SUMMARY

In one aspect, an optical plate includes a transparent layer and a light diffusion layer. The transparent layer includes a light input interface, a light output surface opposite to the light input interface, and a plurality of micro protrusions formed at the light output surface. Each of the micro protrusions includes at least three side surfaces connecting with each other. A transverse width of each side surface decreases along a direction from a base end of the micro protrusion to a distal end of the micro protrusion. The light diffusion layer is integrally formed in immediate contact with the light input interface of the transparent layer. The light diffusion layer includes a transparent matrix resins and a plurality of diffusion particles dispersed into the transparent matrix resins.

In another aspect, a method for making at least one optical plate includes: heating a first transparent matrix resin to be melted for forming a transparent layer, and heating a second transparent matrix resin to be melted for forming a light diffusion layer; injecting the first melted transparent matrix resin into a first molding cavity of a two-shot injection mold to form the transparent layer, the two-shot injection mold including a female mold and at least one male mold, the female mold defining at least one molding groove for engaging with the male mold, the female mold includes a plurality of depressions in a bottom surface defined in an inmost end of the molding groove, the molding groove and the male mold cooperatively defining the first molding cavity, each depression including at least three inner side surfaces, a transverse width of each side surface of the depression progressively increasing along a direction from an inmost end of the depression to an outmost end of the depression, a portion of the at least one molding cavity and the at least one male mold cooperatively forming the first molding chamber; moving the male mold a definite distance away from the inmost end of the at least one molding cavity of the female mold so as to form a second molding cavity; injecting the second melted transparent matrix resin into a second molding cavity to form the light diffusion layer of the optical plate on the transparent layer, a portion of the at least one molding cavity, the transparent layer, and the at least one male mold cooperatively forming the second molding chamber; and taking the formed optical plate out of the two-shot injection mold.

In still another aspect, another method for making an optical plate includes: heating a first transparent matrix resin to a melted state; heating a second transparent matrix resin to a melted state; injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber; withdrawing the first male mold from the female mold; injecting the melted second transparent matrix resin into a second molding chamber of the two-shot injection mold to form a transparent layer of the optical plate on the light diffusion layer, the molding cavity of the female mold receiving the second one of the male molds, the second male mold defining a plurality of depressions in a molding surface thereof, each depression including at least three inner side surfaces, a transverse width of each side surface of the depression progressively increasing along a direction from an inmost end of the depression to an outmost end of the depression, a portion of the molding cavity, the light diffusion layer, and the second male mold cooperatively forming the second molding chamber; and taking the combined light diffusion layer and transparent layer out of the molding cavity of the female mold.

Other advantages and novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and method. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view taken along line II-II of FIG. 1.

FIG. 3 is a cross-sectional view taken along line III-III of FIG. 1.

FIG. 4 is a graph of relative luminance varying according to viewing angle in respect of a conventional backlight module without an optical plate, the viewing angles being measured in four different planes.

FIG. 5 a graph of relative luminance varying according to viewing angle in respect of a backlight module having an optical plate in accordance with the first embodiment of the present invention, the viewing angles being measured in four different planes, the four different planes being the same as the four different planes relating to the graph of FIG. 4.

FIG. 6 is a graph of relative luminance varying according to viewing angle in respect of four different backlight modules including among them the backlight module relating to the graph of FIG. 4 and the backlight module relating to the graph of FIG. 5, the viewing angles being measured in a first one of the four different planes relating to the graphs of each of FIG. 4 and FIG. 5.

FIG. 7 is a graph of relative luminance varying according to viewing angle in respect of the four different backlight modules relating to the graph of FIG. 6, the viewing angles being measured in a second one of the four different planes relating to the graphs of each of FIG. 4 and FIG. 5.

FIG. 8 is an isometric view of an optical plate in accordance with a second embodiment of the present invention.

FIG. 9 is an isometric view of an optical plate in accordance with a third embodiment of the present invention.

FIG. 10 is a side cross-sectional view of a two-shot injection mold used in an exemplary method for making the optical plate of FIG. 1, showing formation of a transparent layer of the optical plate.

FIG. 11 is similar to FIG. 10, but showing subsequent formation of a diffusion layer of the optical plate on the transparent layer, and showing simultaneous formation of a transparent layer of a second optical plate.

FIG. 12 is a side, cross-sectional view of another two-shot injection mold used in another exemplary method for making the optical plate of FIG. 1.

FIG. 13 is an exploded, side cross-sectional view of a conventional backlight module.

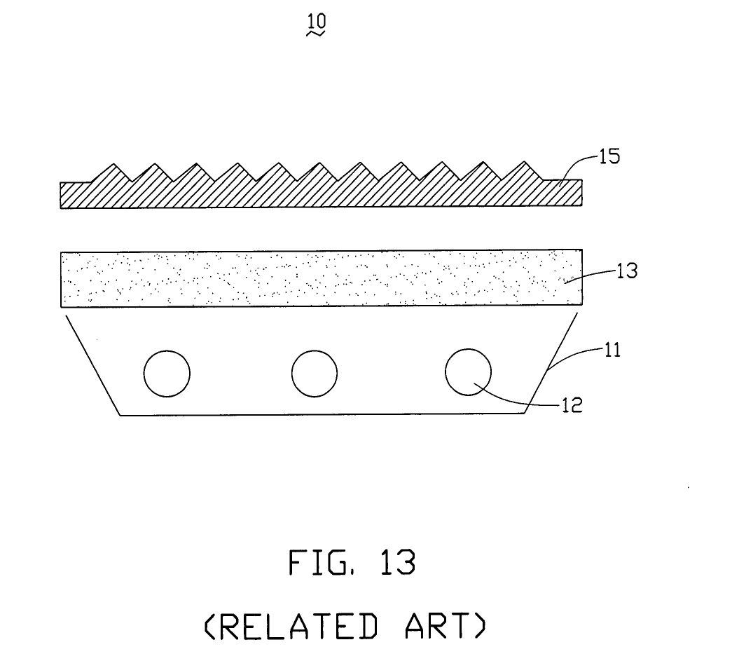

### DETAILED DESCRIPTION OF THE EMBODIMENTS

Reference will now be made to the drawings to describe preferred embodiments of the present optical plate and method for making the optical plate, in detail.

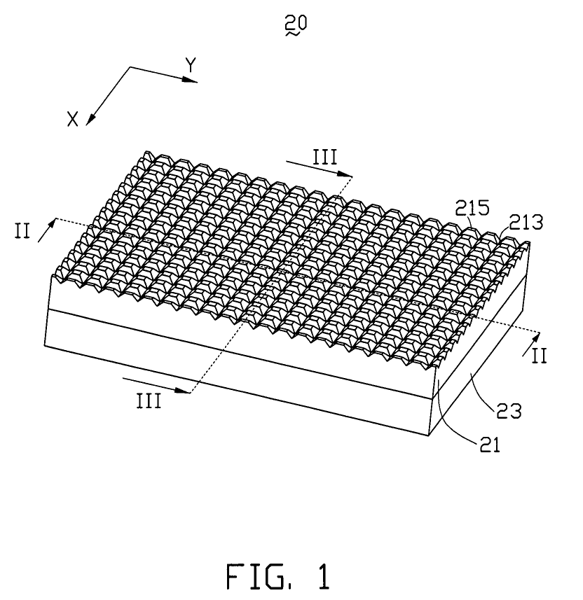

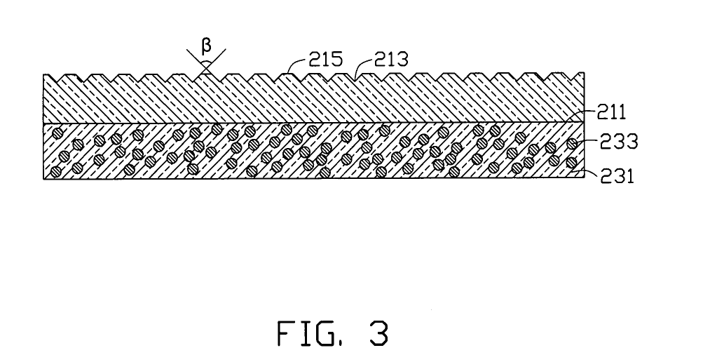

Referring now to FIGS. 1 through 3, these show an optical plate 20 according to a first embodiment of the present invention. The optical plate 20 includes a transparent layer 21 and a light diffusion layer 23. The transparent layer 21 and light diffusion layer 23 are integrally formed by a two-shot injection mold. Thus, the transparent layer 21 and the light diffusion layer 23 are in immediate contact with each other at a common interface thereof. The transparent layer 21 includes a light input interface 211, a light output surface 213 opposite to the light input interface 211, and a plurality of micro protrusions 215 formed at the light output surface 213. The light diffusion layer 23 is located on the light input interface 211. The light diffusion layer 23 includes a transparent matrix resin 231, and a plurality of diffusion particles 233 dispersed in the transparent matrix resin 231. A thickness of the transparent layer 21 and a thickness of the light diffusion layer 23 can each be equal to or greater than 0.35 millimeters. In the illustrated embodiment, a total thickness of the transparent layer 21 and the light diffusion layer 23 is in the range from 1 millimeter to 6 millimeters.

The transparent layer 21 can be made of one or more transparent matrix resins selected from the group including polyacrylic acid (PAA), polycarbonate (PC), polystyrene (PS), polymethyl methacrylate (PMMA), methylmethacrylate and styrene (MS), and so on. The light input interface 211 of the transparent layer 21 can be either smooth or rough.

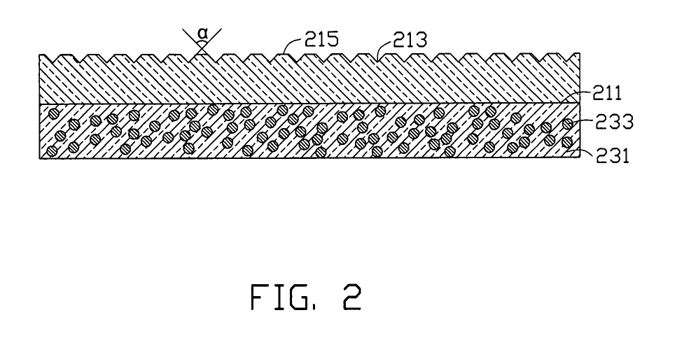

The transparent layer 21 defines a plurality of first and second elongated V-shaped grooves (not labeled) at the light output surface 213. The first elongated V-shaped grooves are parallel to each other and spaced apart regularly, with each first elongated V-shaped groove being aligned along a first direction (the X direction shown in FIG. 2). The second elongated V-shaped grooves are parallel to each other and spaced apart regularly, with each second elongated V-shaped groove being aligned along a second direction (the Y direction shown in FIG. 2). The first V-shaped grooves intersect with the second V-shaped grooves at right angles; in other words, the first direction is perpendicular to the second direction. A depth of each second V-shaped groove is equal to that of each first V-shaped groove. Thereby, the micro protrusions 215 are defined at the light output surface 213 in a regular matrix.

The micro protrusions 215 are configured for cooperatively collimating light rays emitting from the optical plate 20, thereby improving the brightness of light illumination. In the illustrated embodiment, the micro protrusions 215 are substantially rectangular pyramidal-like frustums. Each pyramidal-like frustum includes a pair of opposite, trapezoidal first side surfaces, a pair of opposite, trapezoidal second side surfaces, and a rectangular top surface connecting with the four side surfaces. The first side surfaces have a similar trapezoidal shape to the trapezoidal shape of the second side surfaces. In each line of pyramidal-like frustums along the first direction, corresponding of the first side surfaces of the pyramidal-like frustums are coplanar with one another and regularly aligned parallel to the first direction. In each line of pyramidal-like frustums along the second direction, corresponding of the second side surfaces of the pyramidal-like frustums are coplanar with one another and regularly aligned parallel to the second direction. The first side surfaces of each pyramidal-like frustum cooperatively define an imaginary apex angle α. The second side surfaces of each pyramidal-like frustum cooperatively define an imaginary apex angle β. Each of the angles α and β is preferred to be in the range from 60 degrees to 150 degrees. By appropriately configuring the angles α and β of the pyramidal-like frustums, a desired rate of light enhancement and range of light output angles can be obtained for the optical plate 20. In the illustrated embodiment, the angle α is the same the angle β. A pitch two adjacent micro protrusions 215 along each of the first and second directions is preferably in the range from about 0.0025 millimeters to about 1 millimeter. It should be understood that in alternative embodiments, the first and second side surfaces of each pyramidal-like frustum can be other different quadrangles instead of being trapezoidal.

The light diffusion layer 23 preferably has a light transmission ratio in the range from 30% to 98%. The light diffusion layer 23 is configured for enhancing optical uniformity. The transparent matrix resin 231 can be one or more transparent matrix resins selected from the group including polyacrylic acid (PAA), polycarbonate (PC), polystyrene, polymethyl methacrylate (PMMA), methylmethacrylate and styrene (MS), and any suitable combination thereof. The diffusion particles 233 can be made of material selected from the group including titanium dioxide, silicon dioxide, acrylic resin, and any combination thereof. The diffusion particles 233 are configured for scattering light rays and enhancing the light distribution capability of the light diffusion layer 23.

When the optical plate 20 is utilized in a typical backlight module, light rays from lamp tubes (not shown) of the backlight module enter the light diffusion layer 23 of the optical plate 20. The light rays are substantially diffused in the light diffusion layer 23. Subsequently, many or most of the light rays are condensed by the micro protrusions 215 of the transparent layer 21 before they exit the light output surface 212. As a result, a brightness of light provided by the backlight module is increased. In addition, the transparent layer 21 and the light diffusion layer 23 are integrally formed together, with no air or gas pockets trapped therebetween (see above). This increases the efficiency of utilization of light rays.

Furthermore, when the optical plate 20 is utilized in the backlight module, it can replace the conventional combination of a diffusion plate and a prism sheet. Thereby, the process of assembly of the backlight module is simplified. Moreover, the volume occupied by the optical plate 20 is generally less than that occupied by the combination of a diffusion plate and a prism sheet. Thereby, the volume of the backlight module is reduced. Still further, the single optical plate 20 instead of the combination of two optical plates/sheets can save on costs.

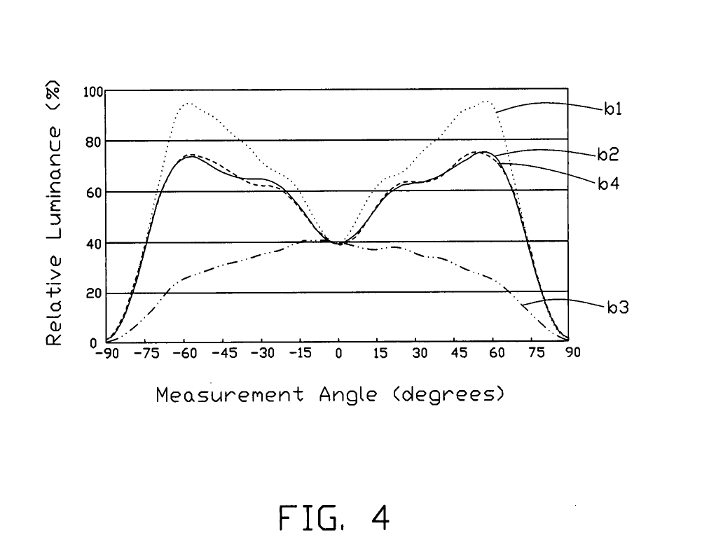

Optical characteristics of the optical plate 20 have been tested, and corresponding data in respect of four different backlight modules is shown in Table 1 below. The results are illustrated in FIGS. 4-7. In the testing process, a housing (not shown) and a plurality of lamp tubes (not shown) were provided for testing the four sample backlight modules. The four backlight modules included one control backlight module (no optical plate), one backlight module with a conventional optical plate, one backlight module with a conventional prism sheet, and one backlight module configured with the optical plate 20.

TABLE 1

| Sample no. | Sample description |
|---|---|
| a0 | backlight module without optical plate |
| a1 | backlight module with a conventional light diffusing plate |
| a2 | backlight module with a conventional prism sheet |
| a3 | backlight module with the present optical plate |

According to the tests, a backlight module is assumed to provide a vertically oriented planar light source. A center axis of the planar light source that lies in the plane and is horizontal is defined as a horizontal axis. A center axis of the planar light source that lies in the plane and is vertical is defined as a vertical axis. The horizontal axis and the vertical axis intersect at an origin. Four ranges of viewing angles are defined. Each range of viewing angles is from −90° to 90° (a total span of 180°), measured at the origin. Each range of viewing angles occupies a plane that is perpendicular to the planar light source. A first range of viewing angles occupies a plane that coincides with the vertical axis. A second range of viewing angles occupies a plane that is oriented 45° away from the first range of viewing angles in a first direction. A third range of viewing angles occupies a plane that coincides with the horizontal axis. A fourth range of viewing angles occupies a plane that is oriented 135° away from the first range of viewing angles in the first direction.

FIG. 4 is a graph illustrating curves of viewing angle characteristics of the sample a0. Curves b1, b2, b3, and b4 represent viewing angle characteristics tested along the first through fourth ranges of viewing angles as defined above, respectively.

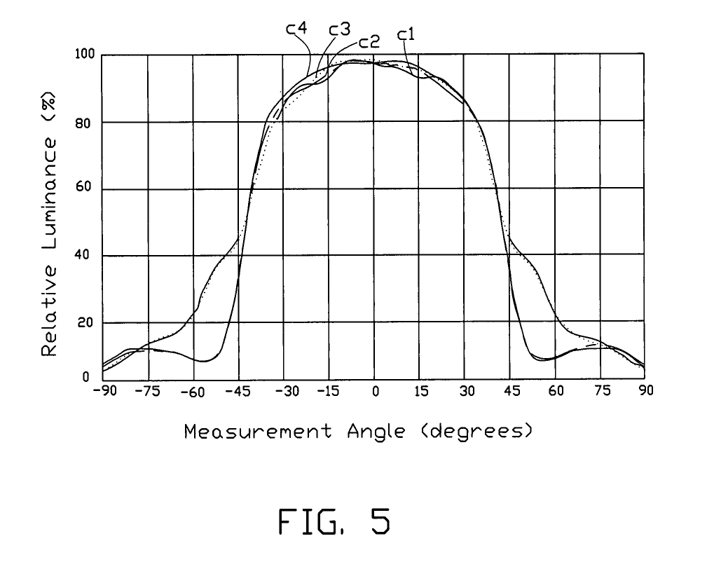

FIG. 5 is a graph illustrating curves of viewing angle characteristics of the sample a3. Curves c1, c2, c3, and c4 represent viewing angle characteristics tested along the first through fourth ranges of viewing angles as defined above, respectively.

In FIGS. 4 and 5, it can be seen that the four curves b1, b2, b3, and b4 are substantially different from each other, whereas the four curves c1, c2, c3, and c4 are substantially similar to each other. It can be concluded that the optical plate 20 greatly improves the uniformity of light output by the backlight module.

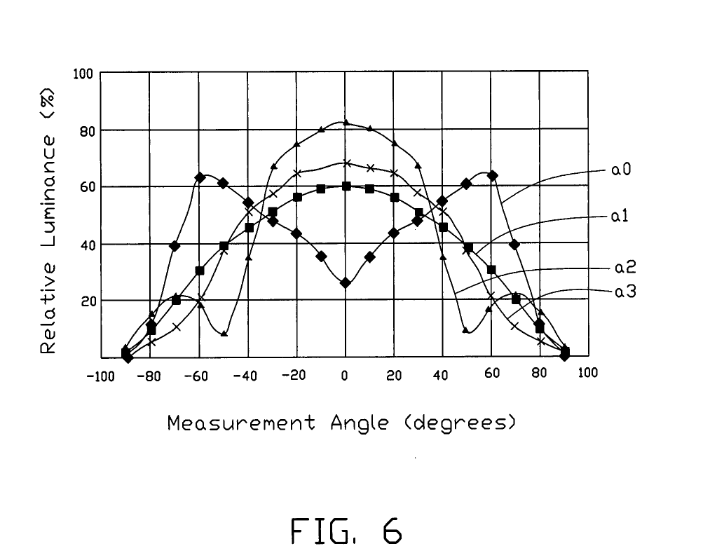

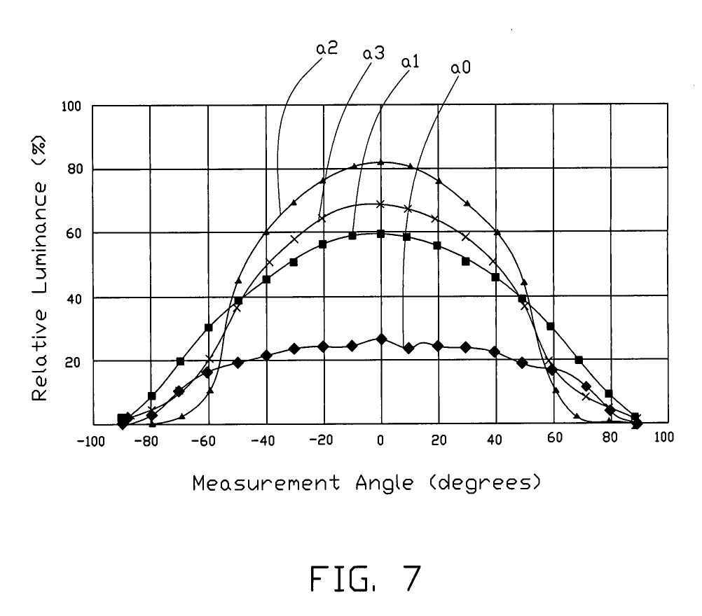

FIG. 6 is a graph illustrating curves of viewing angle characteristics of the samples a0, a1, a2, and a3 measured in the first range of viewing angles. FIG. 7 is a graph illustrating curves of viewing angle characteristics of the samples a0, a1, a2, and a3 measured in the third range of viewing angles. It can be seen that in both the first and third ranges of viewing angles, the sample a3 has a higher brightness in a range from about −40 degrees to about 40 degrees than the sample a1. That is, the sample a3 has a higher brightness in the middle. It can also be seen that in both the first and third ranges of viewing angles, an attenuation of brightness of the sample a3 in a range from 40 degrees to 60 degrees (and similarly in a range from −60 degrees to −40 degrees) changes more gradually than that of the sample a2. Therefore the sample a3 can provide a broader range of angles of viewing (i.e., viewing angle).

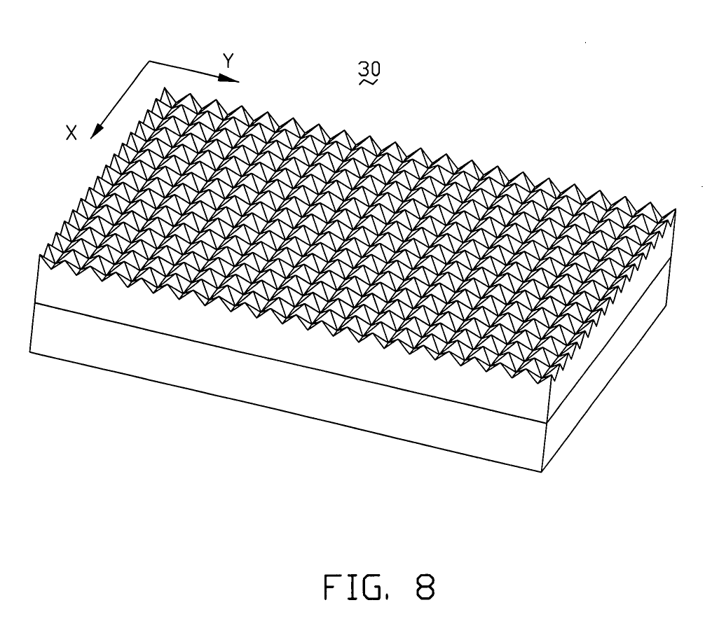

Referring to FIG. 8, an optical plate 30 according to a second embodiment of the present invention is shown. The optical plate 30 is similar in principle to the optical plate 20 described previously, except that the micro protrusions are rectangular pyramids. Each rectangular pyramid includes a pair of opposite first side surfaces and a pair of opposite second side surfaces. The first and second side surfaces are triangular, and the shape of the first side surfaces is similar to the shape of the second side surfaces. In each line of pyramids along a first direction (the X direction shown in FIG. 8), corresponding of the first side surfaces of the pyramids are coplanar with one another and regularly aligned parallel to the first direction. In each line of pyramids along a second direction (the Y direction shown in FIG. 8), corresponding of the second side surfaces of the pyramids are coplanar with one another and regularly aligned parallel to the second direction. The first side surfaces of each pyramid define a first apex angle. The second side surfaces of each pyramid define a second apex angle. In the illustrated embodiment, the first apex angle is the same the second apex angle. Each of the first and second apex angles is preferred to be in the range from 60 degrees to 120 degrees.

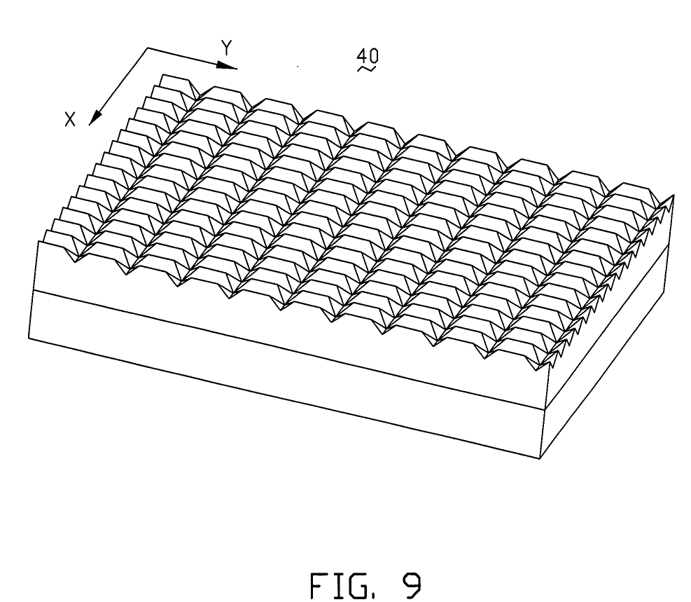

Referring to FIG. 9, an optical plate 40 according to a third embodiment of the present invention is shown. The optical plate 40 is similar in principle to the optical plate 30 described above. However, the optical plate 40 includes a plurality of rectangular pyramid-like micro protrusions formed at a light output surface thereof. Each pyramid-like micro protrusion includes a pair of opposite, triangular first side surfaces, and a pair of opposite, trapezoidal second side surfaces. In each line of pyramid-like micro protrusions along a first direction (the X direction shown in FIG. 9), corresponding of the first side surfaces of the pyramid-like micro protrusions are coplanar with one another and regularly aligned parallel to the first direction. In each line of pyramid-like micro protrusions along a second direction (the Y direction shown in FIG. 9), corresponding of the second side surfaces of the pyramid-like micro protrusions are coplanar with one another and regularly aligned parallel to the second direction.

In alternative embodiments of any of the above-described optical plates 20, 30, 40, the parallel first V-shaped grooves intersect with the parallel second V-shaped grooves at oblique angles. That is, the first direction can be oblique to the second direction, with the first and second directions intersecting at any desired angle in the range from 1 degree to 89 degrees. The present micro protrusions are not limited to being aligned regularly in a matrix, and can instead be aligned otherwise. For example, the micro protrusions in each of rows of the micro protrusions can be staggered relative to the micro protrusions in each of two adjacent rows of the micro protrusions. In addition, each of the micro protrusions may instead be square pyramidal-like frustums or square pyramids. Further, each of the micro protrusions may instead have only three side surfaces connecting with each other. That is, the micro protrusions can be triangular pyramidal-like frustums or triangular pyramids. Moreover, each of the micro protrusions may instead have five side surfaces or more than five side surfaces. That is, the micro protrusions can be polygonal pyramidal-like frustums or polygonal pyramids.

An exemplary method for making the optical plate 20 will now be described. The optical plate 20 is made using a two-shot injection molding technique.

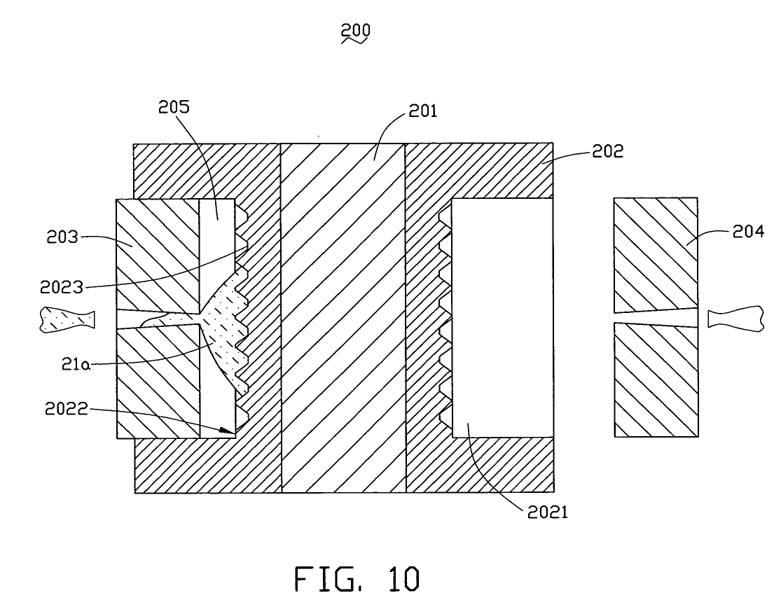

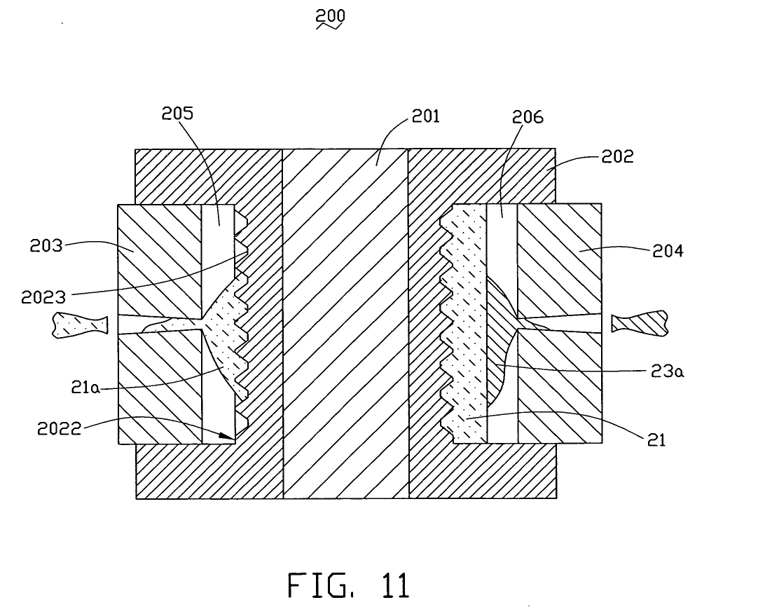

Referring to FIGS. 10-11, a two-shot injection mold 200 is provided for making the optical plate 20. The two-shot injection mold 200 includes a rotating device 201, a first mold 202 functioning as two female molds, a second mold 203 functioning as a first male mold, and a third mold 204 functioning as a second male mold. The first mold 202 defines two molding cavities 2021, and includes an inmost surface 2022 at an inmost end of each of the molding cavities 2021. The first mold 202 defines a plurality of depressions 2023 arranged in a regular matrix at each of the inmost surfaces 2022. Each of the depressions 2023 has a shape corresponding to the shape of each of the micro protrusions 215 of the optical plate 20. Thus each of the depressions 2023 is configured to be a rectangular pyramidal-like frustum-shaped depression, which has a pair of opposite first inner side surfaces and a pair of opposite second inner side surfaces. The first and second inner side surfaces are trapezoidal in shape. The first inner side surfaces have a similar trapezoidal shape to the trapezoidal shape of the second inner side surfaces. A transverse width of each first inner side surface of each depression 2023 progressively increases along a direction from an inmost end of the depression 2023 to an outmost end of the depression 2023, and a transverse width of each second inner side surface of the depression 2023 progressively increases along the direction from the inmost end of the depression 2023 to the outmost end of the depression 2023.

In a molding process, a first transparent matrix resin 21a is melted. The first transparent matrix resin 21a is for making the transparent layer 21. A first one of the molding cavities 2021 of the first mold 202 slidingly receives the second mold 203, so as to form a first molding chamber 205 for molding the first transparent matrix resin 21a. Then, the melted first transparent matrix resin 21a is injected into the first molding chamber 205. After the transparent layer 21 is formed, the second mold 203 is withdrawn from the first molding cavity 2021. The first mold 202 is rotated about 180° in a first direction. A second transparent matrix resin 23a is melted. The second transparent matrix resin 23a is for making the light diffusion layer 23. The first molding cavity 2021 of the first mold 202 slidingly receives the third mold 204, so as to form a second molding chamber 206 for molding the second transparent matrix resin 23a. Then, the melted second transparent matrix resin 23a is injected into the second molding chamber 206. After the light diffusion layer 23 is formed, the third mold 204 is withdrawn from the first molding cavity 2021. The first mold 202 is rotated further in the first direction, for example about 90 degrees, and the solidified combination of the transparent layer 21 and the light diffusion layer 23 is removed from the first molding cavity 2021. In this way, the optical plate 20 is formed using the two-shot injection mold 200.

As shown in FIG. 11, when the light diffusion layer 23 is being formed in the first molding cavity 2021, simultaneously, a transparent layer 21 for a second optical plate 20 can be formed in the second one of the molding cavities 2021. Once the first optical plate 20 is removed from the first molding cavity 2021, the first mold 202 is rotated still further in the first direction about 90 degrees back to its original position. Then the first molding cavity 2021 slidingly receives the second mold 203 again, and a third optical plate 20 can begin to be made in the first molding chamber 205. Likewise, the second molding cavity 2021-having the transparent layer 21 for the second optical plate 20 slidingly receives the third mold 204, and a light diffusion layer 23 for the second optical plate 20 can begin to be made in the second molding chamber 206.

In an alternative embodiment of the above-described molding process(es), after the third mold 204 is withdrawn from the first molding cavity 2021, the first mold 202 can be rotated in a second direction opposite to the first direction. For example, the first mold 202 can be rotated about 90 degrees in the second direction. Then the solidified combination of the transparent layer 21 and the light diffusion layer 23 is removed from the first molding cavity 2021, such solidified combination being the first optical plate 20. Once the first optical plate 20 has been removed from the first molding cavity 2021, the first mold 202 is rotated further in the second direction about 90 degrees back to its original position.

The transparent layer 21 and light diffusion layer 23 of each optical plate 20 are integrally formed by the two-shot injection mold 200. Therefore no air or gas is trapped between the transparent layer 21 and light diffusion layer 23. Thus the interface between the two layers 21, 23 provides for maximum unimpeded passage of light therethrough.

It should be understood that the first optical plate 20 can be formed using only one female mold, such as that of the first mold 202 at the first molding cavity 2021 or the second molding cavity 2021, and one male mold, such as the second mold 203 or the third mold 204. For example, a female mold such as that of the first molding cavity 2021 can be used with a male mold such as the second mold 203. In this kind of embodiment, the transparent layer 21 is first formed in a first molding chamber cooperatively formed by the male mold moved to a first position and the female mold. Then the male mold is separated from the transparent layer 21 and moved a short distance to a second position. Thus a second molding chamber is cooperatively formed by the male mold, the female mold, and the transparent layer 21. Then the light diffusion layer 23 is formed on the transparent layer 21 in the second molding chamber.

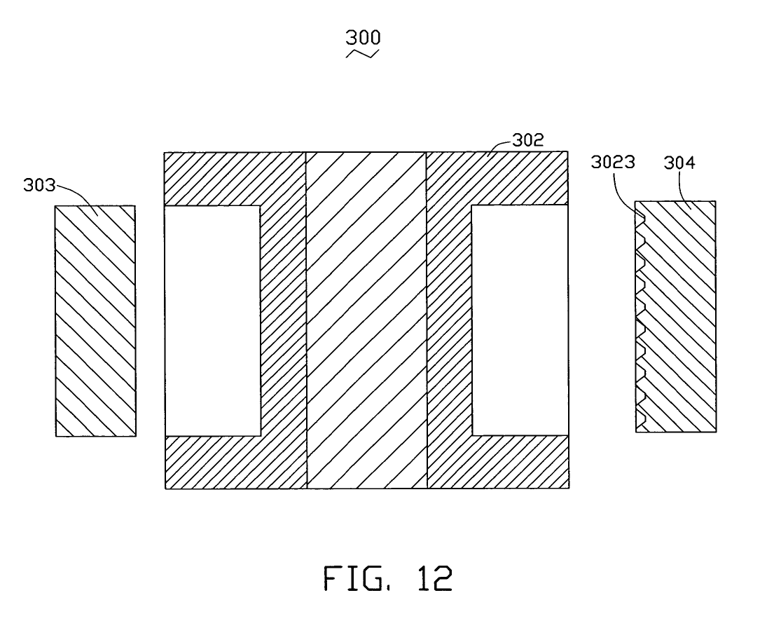

Referring to FIG. 12, in an alternative exemplary method for making the optical plate 20, a two-shot injection mold 300 is provided. The two-shot injection mold 300 is similar in principle to the two-shot injection mold 200 described above, except that a plurality of depressions 3023 are defined in a molding surface of a male mold 304. The depressions 3023 are arranged in a regular matrix. The third mold 304 functions as a second male mold. Each of the depressions 3023 has a shape corresponding to that of each of the micro protrusions 215 of the optical plate 20. In the method for making the optical plate 20 using the two-shot injection mold 300, firstly, a melted first transparent matrix resin is injected into a first molding chamber formed by a first mold 302 and a second mold 303, so as to form the light diffusion layer 23. Then, the first mold 302 is rotated 1800 in a first direction. The first mold 302 slidingly receives the third mold 304, so as to form a second molding chamber. A melted second transparent matrix resin is injected into the second molding chamber, so as to form the transparent layer 21 on the light diffusion layer 23.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A two-layer optical plate, comprising:
a transparent layer including a light input interface, a light output surface opposite to the light input interface, and a plurality of micro protrusions formed at the light output surface, each of the micro protrusions including at least three side surfaces connecting with each other, wherein a transverse width of each side surface decreases along a direction from a base end of the micro protrusion to a distal end of the micro protrusion; and
a light diffusion layer integrally molded in immediate contact with the light input interface of the transparent layer such that there are no air or gas pockets trapped between the transparent layer and the light diffusion layer, the light diffusion layer including a transparent matrix resin and a plurality of diffusion particles dispersed in the transparent matrix resin.

2. The two-layer optical plate as claimed in claim 1, wherein a thickness of the transparent layer and a thickness of the light diffusion layer are each equal to or greater than 0.35 mm.

3. The two-layer optical plate as claimed in claim 2, wherein the transparent matrix resin is selected from one or more of the group consisting of polyacrylic acid, polycarbonate, polystyrene, polymethyl methactylate, methylmethacrylate and styrene, and any combination thereof.

4. The two-layer optical plate as claimed in claim 2, wherein the diffusion particles are made of material selected from the group consisting of titanium dioxide, silicon dioxide, acrylic resin, and any combination thereof.

5. The two-layer optical plate as claimed in claim 1, wherein the transparent layer defines a plurality of first elongated V-shaped grooves and a plurality of second elongated V-shaped grooves at the light output surface, the first elongated V-shaped grooves are parallel to each other and spaced apart regularly, with each first elongated V-shaped groove being aligned along a first direction, the second elongated V-shaped grooves are parallel to each other and spaced apart regularly, with each second elongated V-shaped groove being aligned along a second direction intersecting with the first direction, and thereby the micro protrusions are arranged at the light output surface in a matrix.

6. The two-layer optical plate as claimed in claim 5, wherein the micro protrusions are rectangular pyramidal-like frustums each including a pair of opposite, trapezoidal first side surfaces, a pair of opposite, trapezoidal second side surfaces, and a rectangular top surface connecting with the four side surfaces, in each line of pyramidal-like frustums along the first direction, corresponding of the first side surfaces of the pyramidal-like frustums are coplanar with one another and aligned parallel to the first direction, and in each line of pyramidal-like frustums along the second direction, corresponding of the second side surfaces of the pyramidal-like frustums are coplanar with one another and aligned parallel to the second direction.

7. The two-layer optical plate as claimed in claim 6, wherein the first side surfaces of each pyramidal-like frustum cooperatively define a first apex angle, the second side surfaces of each pyramidal-like frustum cooperatively define a second apex angle, and each of the first and second apex angles is in the range from 60 degrees to 150 degrees.

8. The two-layer optical plate as claimed in claim 5, wherein a pitch between two adjacent micro protrusions along each of the first and second directions is in the range from about 0.0025 millimeters to about 1 millimeter.

9. The two-layer optical plate as claimed in claim 1, wherein the micro protrusions are selected from the group consisting of rectangular pyramidal-like frustums, rectangular pyramids, square pyramidal-like frustums, square pyramids, triangular pyramidal-like frustums, triangular pyramids, polygonal pyramidal-like frustums, and polygonal pyramids.

10-16. (canceled)
